(19) United States
(12) Patent Application Publication
(10) Pub. No.: US 2002/0136234 A1
(43) Pub. Date: Sep. 26, 2002

(54) Tuning the fingers of rake receiver

(76) Inventors: Hakan Eriksson, Lund (SE); Johan Nilsson, Malmo (SE); Anders Ericsson, Sodra Sandb (SE)

Correspondence Address: Ronald L. Grudziecki, Esquire, BURNS, DOANE, SWECKER & MATHIS, L.L.P., P. O. Box 1404, Alexandria, VA, 22313-1404, US

(21) Appl. No.: 09/782,188

(22) Filed: Feb. 14, 2001

(51) Int. Cl. H04L 12/43

(52) U.S. Cl. 370/458; 370/345

(57) ABSTRACT

Path delays experienced by a received signal are estimated for use in, for example, a RAKE receiver. This involves hypothesizing a plurality of path delays. For each of a plurality of measurement time slots and for each of the hypothesized path delays, a measurement based on the received signal is made along with a determination of whether a fade occurred. For each of the plurality of measurement time slots and for each of the hypothesized path delays, the measurement is combined with a corresponding one of a plurality of cumulative metrics only if it was determined that no fade occurred. Then, for each of the plurality of hypothesized path delays, the corresponding one of the plurality of cumulative metrics is used to determine whether the hypothesized path delay corresponds to a real path delay.

### BACKGROUND

The present invention relates to communications systems, more particularly to RAKE receivers, and even more particularly to techniques for estimating path delays associated with a communications channel.

A cellular communication system is one in which a large geographical area is divided up into so-called cells. Each cell is served by a corresponding base station, which uses radiocommunication techniques to link mobile units located within the cell to a land-based part of the cellular communication system. The land-based part of the cellular communication system is capable not only of linking communications between mobile units located in the same or different cells, but also of connecting a mobile user to other communications networks, such as a Public Switched Telephone Network (PSTN) and/or a computer-oriented data network. In this way, a mobile user may be capable of establishing a call to (or receiving a call from) a non-mobile telephone (a so-called “Plain Old Telephone”, or “POT”) or to processing equipment connected to a computer network. When a user of a mobile unit moves from one cell to another, responsibility for maintaining any ongoing call that he may be participating in shifts from the original cell to the new “target” cell, in an operation referred to as “handoff” or “handover”.

The cellular radiocommunication industry has made phenomenal strides in commercial operations in the United States as well as the rest of the world. Growth in major metropolitan areas has far exceeded expectations and is rapidly outstripping system capacity. If this trend continues, the effects of this industry's growth will soon reach even the smallest markets. Innovative solutions are required to meet these increasing capacity needs as well as to maintain high quality service and avoid rising prices.

Throughout the world, one important step in the advancement of radio communication systems is the change from analog to digital transmission. Equally significant is the choice of an effective digital transmission scheme for implementing next generation technology. Furthermore, it is widely believed that the first generation of Personal Communication Networks (PCNs), employing low cost, pocket-sized, cordless telephones that can be carried comfortably and used to make or receive calls in the home, office, street, car, and the like, will be provided by, for example, cellular carriers using the next generation digital cellular system infrastructure. An important feature desired in these new systems is increased traffic capacity, and efficient use of this capacity.

Currently, channel access is very often achieved using Frequency Division Multiple Access (FDMA) and Time Division Multiple Access (TDMA) methods. In FDMA, a communication channel is a single radio frequency band into which a signal's transmission power is concentrated. Signals that can interfere with a communication channel include those transmitted on adjacent channels (adjacent channel interference) and those transmitted on the same channel in other cells (co-channel interference). Interference with adjacent channels is limited by the use of band pass filters which only pass signal energy within the specified frequency band. Co-channel interference is reduced to tolerable levels by restricting channel reuse such that a minimum separation distance is required to exist between cells in which the same frequency channel is used. Thus, with each channel being assigned a different frequency, system capacity is limited by the available frequencies as well as by limitations imposed by channel reuse.

In TDMA systems, a channel consists of, for example, a time slot in a periodic train of time intervals over the same frequency. Each period of time slots is called a frame. A given signal's energy is confined to one of these time slots on a given frequency. Adjacent channel interference is limited by the use of a time gate or other synchronization element that only passes signal energy received at the proper time. Thus, with each channel being assigned a different time slot, system capacity is limited by the number of available time slots per frequency, as well as by limitations imposed by channel reuse as described above with respect to FDMA, which determines the number of frequencies that are available for use in any given cell.

With FDMA and TDMA systems (as well as hybrid FDMA/TDMA systems), one goal of system designers is to ensure that two potentially interfering signals do not occupy the same frequency at the same time. In contrast, Code Division Multiple Access (CDMA) is a channel access technique that allows signals to overlap in both time and frequency. CDMA is a type of spread spectrum communication technique, which has been around since the days of World War II. Early applications were predominantly military oriented. However, today there has been an increasing interest in using spread spectrum systems in commercial applications because spread spectrum communications provide robustness against interference, which allows for multiple signals to occupy the same bandwidth at the same time. Examples of such commercial applications include digital cellular radio, land mobile radio, and indoor and outdoor personal communication networks.

In a CDMA system, each signal is transmitted using any of a number of spread spectrum techniques. In some variations of CDMA, the informational data stream to be transmitted is impressed upon a much higher rate data stream known as a signature sequence. Typically, the signature sequence data are binary, thereby providing a bit stream. One way to generate this signature sequence is with a pseudo-noise (PN) process that appears random, but can be replicated by an authorized receiver. The informational data stream and the high bit rate signature sequence stream are combined by multiplying the two bit streams together, assuming the binary values of the two bit streams are represented by +1 or −1. This combination of the higher bit rate signal with the lower bit rate data stream is called spreading the informational data stream signal. Each informational data stream or channel is allocated a unique signature sequence.

A plurality of spread information signals modulate a radio frequency carrier, for example by Binary Phase Shift Keying (BPSK), and are jointly received as a composite signal at the receiver. Each of the spread signals overlaps all of the other spread signals, as well as noise-related signals, in both frequency and time. If the receiver is authorized, then the composite signal is correlated with one of the unique signature sequences, and the corresponding information signal can be isolated and despread. If quadrature phase shift keying (QPSK) modulation is used, then the signature sequence may consist of complex numbers (having real and imaginary parts), where the real and imaginary parts are used to modulate respective ones of two carriers at the same frequency, but ninety degrees out of phase with respect to one another.

Traditionally, for example in the case of BPSK modulation, a signature sequence is used to represent one bit of information. Receiving the transmitted sequence or its complement indicates whether the information bit is a +1 or −1, sometimes denoted “0” or “1”. The signature sequence usually comprises N bits, and each bit of the signature sequence is called a “chip”. The entire N-chip sequence, or its complement, is referred to as a transmitted symbol. The conventional receiver, such as a RAKE receiver, correlates the received signal with the complex conjugate of the known signature sequence to produce a correlation value. Only the real part of the correlation value is computed. When a large positive correlation results, a “0”is detected; when a large negative correlation results, a “1” is detected.

RAKE receivers are well-known. A conventional baseband processor 100 in a typical coherent RAKE receiver is illustrated in FIG. 1. The baseband signal is provided to a bank of correlators 101, which correlate different delays of the received signal to the despreading code, producing despread values. The delays are provided by channel delay estimator 103, which uses known methods to estimate the delays, such as finding delays which give large despread values. The despread values corresponding to different delays are combined in combiner 105 using a weighted sum. The weights are the conjugates of channel coefficient estimates provided by channel coefficient estimator 107. For example, correlations to a pilot signal can be used to obtain channel coefficients.

Consider a simple example in which the received chip-spaced baseband samples during one symbol period is represented by r(k). These samples are modeled as

r(k)=bc₀s(k)+bc₁s(k−1)+w(k) (1)

where b is the symbol sent, c₀ and c₁ are the channel coefficients, the delays are 0 and 1 chip period, s(k) is the chip sequence used to spread the symbol, and w(k) are impairment (noise plus interference) samples.

The bank of correlators 101 produces two despread values, denoted x₀ and x₁, corresponding to the two rays. These can be expressed as

$$\begin{matrix}{x}_{0} = \frac{1}{L} {\sum }_{k = 0}^{L - 1} {s}^{*} ( k ) r ( k ) & ( 2 ) \\ {x}_{1} = \frac{1}{L} {\sum }_{k = 0}^{L - 1} {s}^{*} ( k ) r ( k + 1 ) & ( 3 )\end{matrix}$$

where the superscript “*” denotes complex conjugation and L is the despreading factor. Division by L is shown for illustrative purposes, while in practice it is well known how to extend results to the case in which the division is omitted.

The combiner 105 combines the two despread values using estimates of the channel coefficients denoted ĉ₀ and ĉ₁, to produce a detection statistic that corresponds to an information symbol. This can be expressed as

z×ĉ₀*x₀+ĉ₁*x₁ (4)

The symbol value that is closest to z gives the detected value \hat{b}. For BPSK modulation, b is either +1 or −1, so that the detected value is given by the sign of the real part of z.

Channel coefficients can be estimated separately using standard approaches. For example, with Least Mean Squared (LMS) estimation of c₀, one would form the time varying estimate ĉ₀(n), where n is an index denoting symbol period, using

ĉ₀(n+1)=ĉ₀(n)+μ\hat{b}*(n)(x₀(n)−ĉ₀(n)\hat{b}(n)) (5)

where μ is the LMS step size. Also, \hat{b} is the detected symbol value.

It can be seen that the quality of performance of a RAKE receiver is related to how well the channel delay estimator (e.g., the channel delay estimator 103) performs. The more accurate the estimates of signal path delays, the better the RAKE receiver will perform. An exemplary channel delay estimator 200 is illustrated in FIG. 2. The channel delay estimator 200 tests differently delayed versions of the received signal for correlation with a given spreading sequence. For each hypothesized delay, the degree of correlation determines whether the hypothesized delay represents an actual delay experienced by the received signal. To carry out this process, the exemplary channel delay estimator 200 has five “probing fingers”, each associated with one of five hypothesized delays: t₀, t₁, t₂, t₃, and t₄. These could, for example, be equally spaced with respect to one another, such as at 0, Δt, 2Δt, 3Δt, and 4Δt, as illustrated in FIG. 2. By making Δt small, it is possible to fine tune a delay estimate and track changes in the delay. The choice of five probing fingers in this example is merely for illustration: The number of probing fingers in any particular embodiment is a design choice that can be less than, equal to, or greater than five.

Except for introducing a different amount of delay, each probing finger operates in the same manner. Thus, focusing now on the probing finger associated with a delay equal to zero (i.e., no delay), the received signal is supplied to a delay unit 201 that aligns the signal to be processed in accordance with the hypothesized delay (in this case, a delay of zero). The (delayed) received signal is then passed through a matched filter 203, which may alternatively be a bank of correlators. The matched filter 203 generates an estimate of the impulse response of the channel. This estimate is generally a complex-valued signal.

The channel delay estimator 200 may operate in accordance with any of a number of standards. Merely for the purpose of illustration, and to facilitate an understanding of the invention, the exemplary channel delay estimator 200 is presumed to operate in accordance with 3GPP TS 25.211 v3.4.0 (2000-09): Third Generation Partnership Project; Technical Specification Group Radio Access Network; Physical channels and mapping of transport channels onto physical channels (FDD) (Release 1999). Of pertinence here is the fact that time multiplexing is used to define the physical channels. Section 5.3.2 of the 3GPP document defines a frame structure that comprises a number of time slots (“slots”), each associated with a different channel. During each slot, traffic channel information and control channel information are transmitted. In addition, a predetermined number of pilot bits are also transmitted during each slot. Section 5.3.3.1 of the 3GPP document specifies the format of the common pilot channel. The pilot is a predetermined sequence of bits that are known to both the transmitter and the receiver. It is this knowledge that enables the matched filter 203 to generate the estimate of the impulse response of the channel.

If the channel parameters are subject to fast changes, the estimates, made for each of a number N of time slots, are summed non-coherently. This means that the absolute value of the complex signal is determined (block 205), and then summed with the values obtained for the signal during other time slots (summing block 207).

Alternatively, if the channel parameters are subject to slow changes, then the channel estimates may be summed coherently, so that the absolute value block 205 would not be present. In other alternative embodiments, a combination of coherent and non-coherent averaging is also possible.

The fact that the channel is fading will prevent every time slot from contributing to the estimate of the delays. However, the variations of the channel in general are such that the fading process is much faster than the changes of the delays. Thus, if we assume merely for the sake of example that, on average, there are two equally strong paths with gain h₁, and h₂, two peaks will be built up over time in the cumulated sum over different time slots, so long as the delays are sufficiently well separated in time.

A problem exists, however, when the mutual difference in delay between multiple paths is small. In such cases, the accumulated sum can exhibit only one large peak that is situated somewhere between the true delays associated with two or more channel paths. As a consequence, only one path will be detected. This will detrimentally affect the performance of the RAKE receiver since, as mentioned above, the quality of performance of a RAKE receiver is related to how well the channel delay estimator performs.

Thus, there is a need for improved methods and apparatuses for estimating the delays associated with a channel.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

In accordance with one aspect of the present invention, the foregoing and other objects are achieved in methods and apparatuses that estimate path delays experienced by a received signal. These estimates may, for example, be used in a RAKE receiver. Making the path delay estimates involves hypothesizing a plurality of path delays. For each of a plurality of measurement time slots and for each of the hypothesized path delays, a measurement based on the received signal is made along with a determination of whether a fade occurred. For each of the plurality of measurement time slots and for each of the hypothesized path delays, the measurement is combined with a corresponding one of a plurality of cumulative metrics only if it was determined that no fade occurred. Then, for each of the plurality of hypothesized path delays, the corresponding one of the plurality of cumulative metrics is used to determine whether the hypothesized path delay corresponds to a real path delay.

In another aspect of the invention, for each of the plurality of measurement time slots, the measurement is combined with an additional cumulative metric whenever it is determined that no fades occurred for any of the hypothesized path delays. In alternative embodiments, the measurement is combined with the additional cumulative metric regardless of whether it is determined that no fades occurred for any of the hypothesized path delays. In either embodiment, the additional cumulative metric can then be used to determine whether a real path delay exists between two of the hypothesized path delays.

### BRIEF DESCRIPTION OF THE DRAWINGS

The objects and advantages of the invention will be understood by reading the following detailed description in conjunction with the drawings in which:

FIG. 1 is a block diagram of a conventional baseband processor in a typical coherent RAKE receiver;

FIG. 2 is a block diagram of an exemplary channel delay estimator;

FIG. 3 is a block diagram of an exemplary delay estimator for generating gain estimates, ĥ₁ and ĥ₂ in accordance with the invention;

FIGS. 4a, 4b and 4c are graphs that depict absolute values of exemplary received signals;

FIGS. 5a, 5b and 5c are graphs that depict accumulated measurement sums for different fade characteristics, in accordance with an aspect of the invention;

FIG. 6 is a block diagram of an alternative embodiment of a delay estimator for generating gain estimates, ĥ₁ and ĥ₂ in accordance with the invention;

FIG. 7 is a graph that depicts absolute values of exemplary received signals along with hypothesized delays that are spaced relatively far apart with respect to one another; and

FIG. 8 is a graph that depicts absolute values of exemplary received signals along with hypothesized delays that are spaced relatively close to one another.

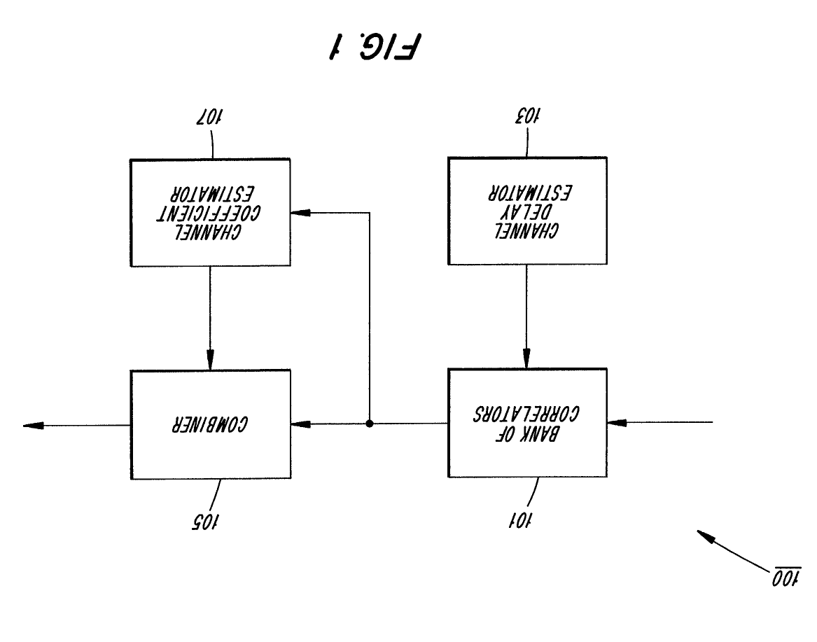

### DETAILED DESCRIPTION

The various features of the invention will now be described with respect to the figures, in which like parts are identified with the same reference characters.

These and other aspects of the invention will now be described in greater detail in connection with a number of exemplary embodiments. To facilitate an understanding of the invention, many aspects of the invention are described in terms of sequences of actions to be performed by elements of a computer system. It will be recognized that in each of the embodiments, the various actions could be performed by specialized circuits (e.g., discrete logic gates interconnected to perform a specialized function), by program instructions being executed by one or more processors, or by a combination of both. Moreover, the invention can additionally be considered to be embodied entirely within any form of computer readable carrier, such as solid-state memory, magnetic disk, optical disk or carrier wave (such as radio frequency, audio frequency or optical frequency carrier waves) containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiment may be referred to herein as “logic configured to” perform a described action, or alternatively as “logic that” performs a described action.

In accordance with one aspect of the invention, improved performance in delay estimation is achieved by making use of channel fades that affect some but not all of the delay paths. When it is detected that one or more particular paths are experiencing a fade, the estimated impulse response of the channel for that time slot is added to the accumulated values associated with only those paths that are not experiencing the fade. This and other aspects of the invention will now be described in greater detail in connection with exemplary embodiments.

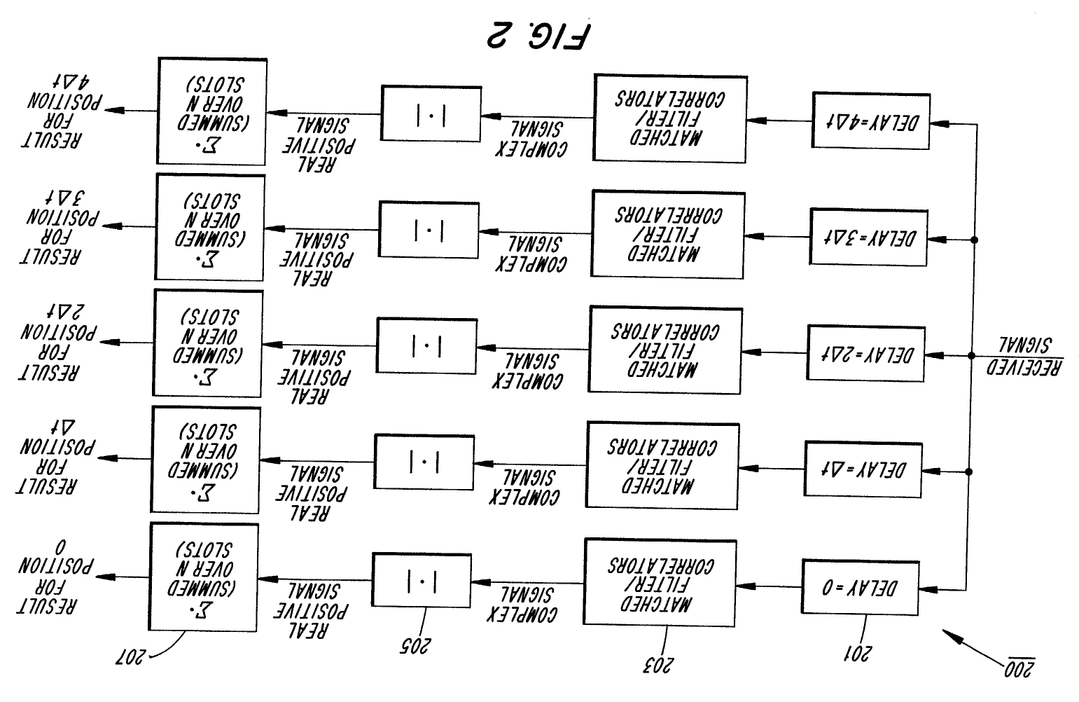

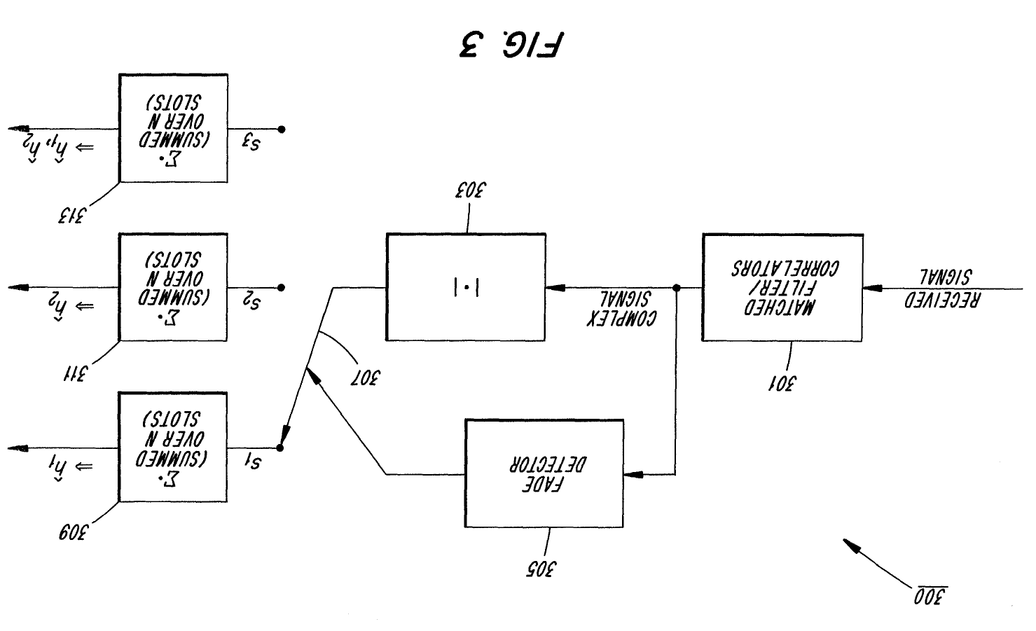

For simplicity, and without loss of generality, consider a two path channel, with gain h₁ and h₂. FIG. 3 is a block diagram of an exemplary delay estimator 300 for generating gain estimates, ĥ₁ and ĥ₂ in accordance with the invention. In comparing this block diagram with that of the exemplary delay estimator 200 shown in FIG. 2, it is useful to understand that the conventional channel delay estimator 200 is depicted having a separate path for each hypothesized delay. As a consequence, the output of each absolute value block 205 is a (possibly complex) scalar. By contrast, the elements depicted in FIG. 3 are repeatedly operated, once for each hypothesized delay. As a consequence, the output of the absolute value block 303 is a complex vector, with each element in the vector representing a correlation value for a corresponding hypothesized delay. The received signal is supplied to a matched filter (or alternatively to a bank of correlators) 301 that generates an estimate of the channel impulse response, which is generally a complex-valued signal. In the exemplary embodiment, a non-coherent mean value calculation is performed, so the absolute value (block 303) of the channel impulse response is determined. In alternative embodiments, coherent summing of the channel impulse response estimates is performed, so that the absolute value block 303 would not be present.

In accordance with an aspect of the invention, the delay estimator 300 includes a fade detector 305 that analyzes the complex signal generated by the matched filter 301 to determine, for each time slot being measured, whether any parts of the received signal associated with any of the hypothesized delays have experienced a fade. The fade detector could, for example, base its detection on channel estimates for hypothesized delays. A simple strategy could be to deem that there is no fading for a particular delay if the momentary channel estimate for this particular delay is large, while the channel is judged as being in a fading dip if the channel estimate is small. The output of the fade detector 305 is a signal that controls whether the output of the absolute value block 303 will contribute to the accumulated sum for only the first hypothesized delay 309, to the accumulated sum for only the second hypothesized delay 311, or to the accumulated sum that represents a delay that is in-between the first and second hypothesized delays 313. This is depicted schematically in FIG. 3 as the output of the fade detector 305 controlling the switch position of a switch 307. In practice, the use of a physical switch 307 is just one of a number of alternative embodiments for achieving this function. For example, in one alternative, the result of fade detection could control branching within a computer program that alternatively achieves accumulation for only the first, only the second or both hypothesized delay paths.

The use of the detected fade for this purpose is based on the principle that if one path fades, a correlation peak for the other path will still be detected, enabling one to distinguish between the existence of two delay paths, and the existence of only a single delay path that is near one of the two hypothesized delay paths. Which state the switch 307 has (i.e., whether it is switch position s₁, s₂, or s₃) is preferably governed by a hypothesis of which of the paths has a sufficiently large gain. This can, for example, be given by a hypothesis scheme that roughly indicates which of the paths is/are present. For example, the possible states of the switch 307 can be given by previous channel estimates.

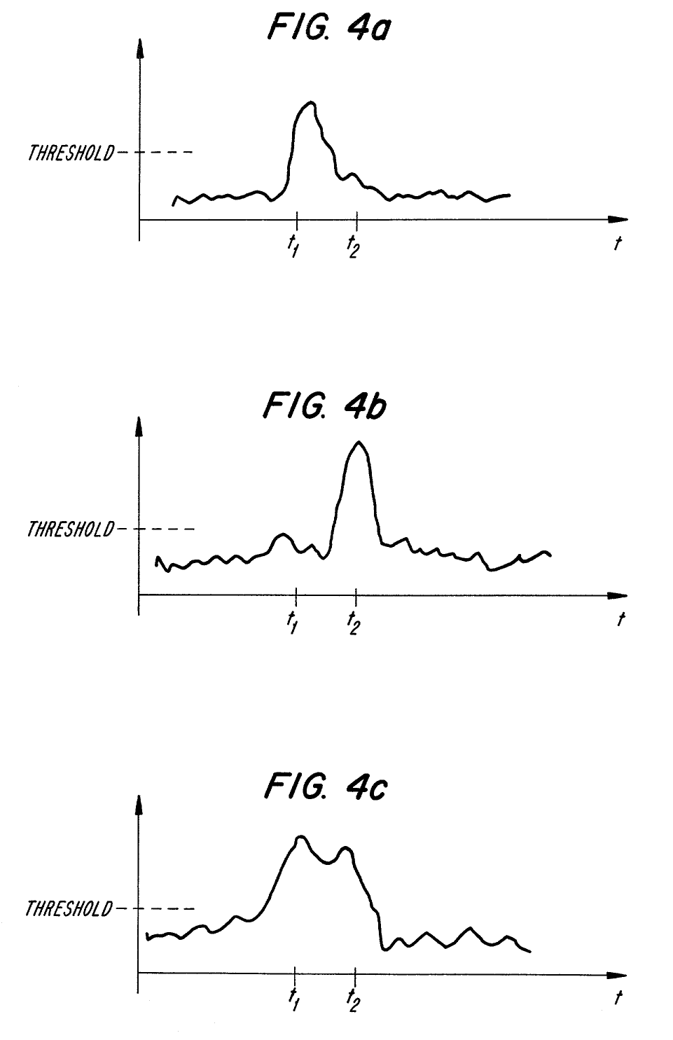

FIGS. 4a, 4b and 4c depict absolute values of exemplary received signals. In FIG. 4a, the amplitude of the signal exceeds a predetermined threshold value (below which the signal is presumed to represent only noise) only around time t₁. Consequently, the fade detector 305 would set the switch 307 to position s₁.

In FIG. 4b, the amplitude of the signal exceeds the predetermined threshold value only around time t₂. Consequently, the fade detector 305 would set the switch 307 to position S₂.

In FIG. 4c, the amplitude of the signal exceeds the predetermined threshold value around both of times t₁ and t₂. Consequently, the fade detector 305 would set the switch 307 to position s₃.

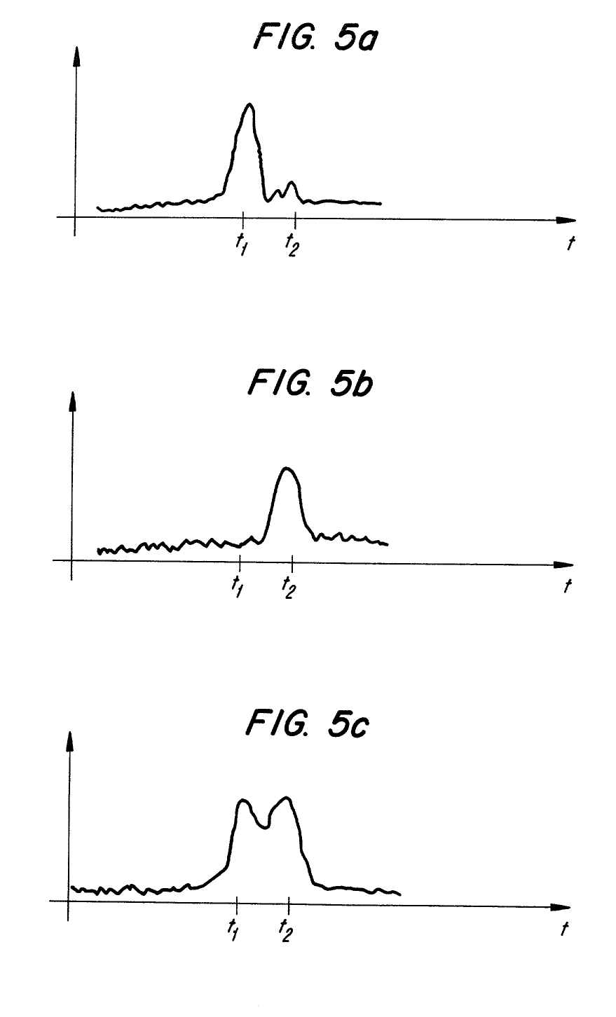

If the above-described technique is used to measure the channel over several slots with independent fading, the various accumulated values over N slots 309, 311, 313 might look as depicted in FIGS. 5a, 5b and 5c. More particularly, FIG. 5a is a graph showing the accumulated sum over N slots 309 corresponding to the switch 307 being in the s₁ position; FIG. 5b is a graph showing the accumulated sum over N slots 311 corresponding to the switch 307 being in the s₂ position; and FIG. 5c is a graph showing the accumulated sum over N slots 313 corresponding to the switch 307 being in the s₃ position. The accumulated sum information corresponding to the s₁ position of the switch 307 (e.g., FIG. 5a) enables the delay estimator 300 to extract the position, t₁, of the peak value. Similarly, the accumulated sum information corresponding to the s₂ position of the switch 307 (e.g., FIG. 5b) enables the delay estimator 300 to extract the position, t₂, of another peak value.

In case the different multipaths were not separated enough to distinguish one from the other, the delay of the corresponding path can be found as the position of the peak of the output in FIG. 5c (i.e., the graph of the accumulated sum corresponding to the switch 307 being in the s₃ position).

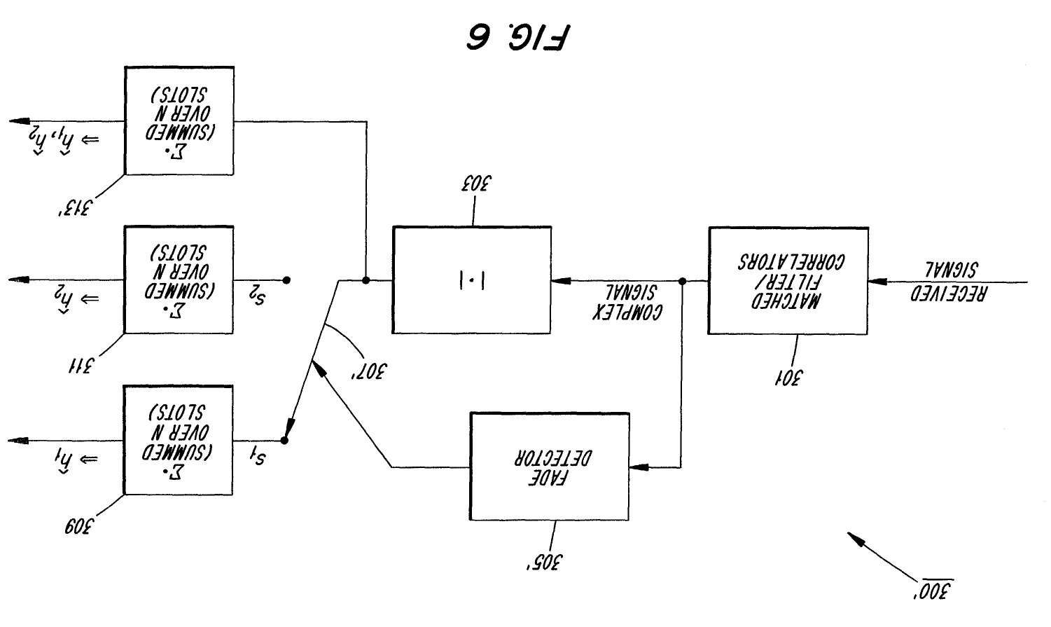

FIG. 6 is a block diagram of an alternative embodiment of a delay estimator 300′ for generating gain estimates, ĥ₁ and ĥ₂ in accordance with the invention. The principle of operation of this embodiment is essentially the same as that described above with respect to FIG. 3. However, in this alternative embodiment, switching is performed only between two switch positions, s₁ and s₂. Hence, the output of the fade detector 305′ only has two states in the exemplary embodiment. The third summing block 313′ is operational at all times, and therefore need not be switched in and out.

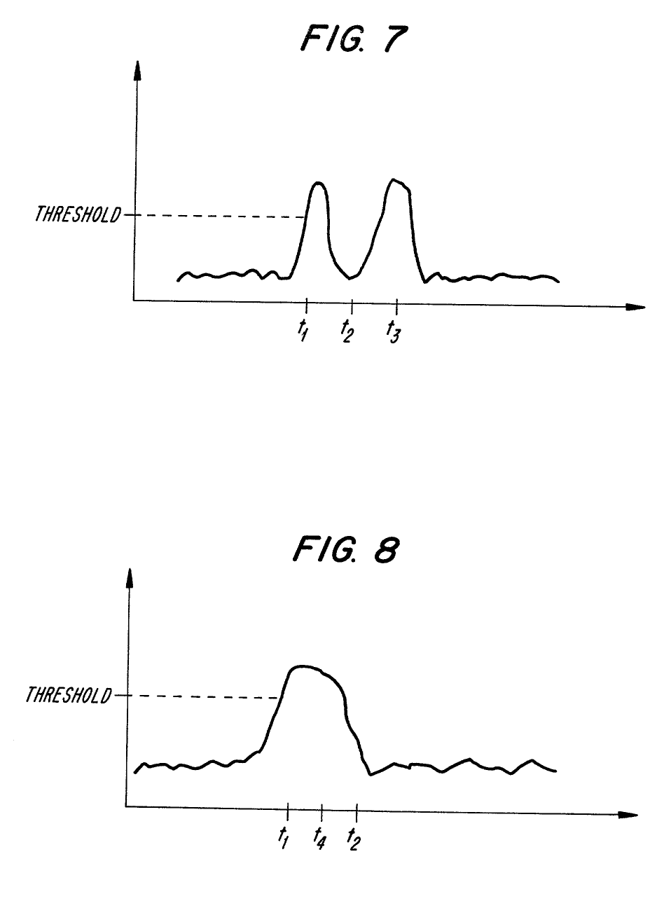

The inventive techniques described herein are most useful when two or more multipath delays are close, but not too close, in time with respect to one another. That is, if the difference between delays is relatively large, the delays are well separated from one another and the problem is rather trivial. This situation is illustrated in FIG. 7, where the distance between the hypothesized delays t₁ and t₃ is relatively large. (The hypothesized delay t₂ from previous examples is shown in FIG. 7 for the purpose of helping to illustrate the relative distance between the hypothesized delays t₁ and t₃.) Conversely, if the delays are very close to one another, such as the distance between the hypothesized delays t₁ and t₄ depicted in FIG. 8 (with the hypothesized delay t₂ from previous examples again being illustrated for the purpose of showing the relative distance between the hypothesized delays t₁ and t₄), the techniques described herein will not be able to separate them; but in this case, the RAKE receiver will not require separation because the resolution of the signal is coarser than the difference between the delays. When the delays are relatively close to one another (but not too close to resolve) the techniques described herein increase the possibility for resolving the different delays by making use of the fact that, because of fading, not all delays have a strong contribution to the signal at all times.

The invention has been described with reference to a particular embodiment. However, it will be readily apparent to those skilled in the art that it is possible to embody the invention in specific forms other than those of the preferred embodiment described above. This may be done without departing from the spirit of the invention.

For example, in some alternative embodiments the delay resolution techniques described herein can be turned on or off based on the distance between the hypothesized delays. This function can be combined with the strategy in the fade detector.

Furthermore, in order to facilitate an understanding of the invention, only the two path case has been illustrated. However, the inventive techniques described herein can easily be generalized to any number of paths having delays that are close to one another. This can be accomplished by providing a new set of fading detectors 305, and accumulators 309, 311, 313 for each pair of multipaths.

Still further, the exemplary embodiments (e.g., illustrated in FIGS. 3 and 6) include an absolute value block 303 that generates the absolute value of the complex signal supplied by the matched filter 301 in order to permit non-coherent summing to take place. Use of an absolute value block 303 is not essential to the invention, however. For example, the block 303 could alternatively generate the square of the absolute value (i.e., the power of the amplitude), or any of numerous other mathematical functions that would not significantly alter the effectiveness of the delay estimator 300, 300′. And as mentioned earlier, in still other alternative embodiments, coherent summing of the channel impulse response estimates is performed, so that the absolute value block 303 would not be present at all.

Thus, the preferred embodiment is merely illustrative and should not be considered restrictive in any way. The scope of the invention is given by the appended claims, rather than the preceding description, and all variations and equivalents which fall within the range of the claims are intended to be embraced therein.

What is claimed is:

1. A method of estimating path delays experienced by a received signal, the method comprising:
hypothesizing a plurality of path delays;
for each of a plurality of measurement time slots and for each of the hypothesized path delays, making a measurement based on the received signal;
for each of the plurality of measurement time slots and for each of the hypothesized path delays, determining whether a fade occurred;
for each of the plurality of measurement time slots and for each of the hypothesized path delays, combining the measurement with a corresponding one of a plurality of cumulative metrics only if it was determined that no fade occurred; and
for each of the plurality of hypothesized path delays, using the corresponding one of the plurality of cumulative metrics to determine whether the hypothesized path delay corresponds to a real path delay.

2. The method of claim 1, further comprising:
for each of the plurality of measurement time slots, combining the measurement with an additional cumulative metric whenever it is determined that no fades occurred for any of the hypothesized path delays; and
using the additional cumulative metric to determine whether a real path delay exists between two of the hypothesized path delays.

3. The method of claim 1, further comprising:
for each of the plurality of measurement time slots, combining the measurement with an additional cumulative metric; and
using the additional cumulative metric to determine whether a real path delay exists between two of the hypothesized path delays.

4. The method of claim 1, wherein the step of, for each of the plurality of measurement time slots and for each of the hypothesized path delays, combining the measurement with the corresponding one of a plurality of cumulative metrics only if it was determined that no fade occurred comprises adding the measurement to the corresponding one of the plurality of cumulative metrics only if it was determined that no fade occurred.

5. The method of claim 1, wherein the measurement based on the received signal is an amplitude measurement of the received signal at a time corresponding to the hypothesized path delay during the measurement time slot.

6. The method of claim 1, wherein the measurement based on the received signal is an absolute value of an amplitude measurement of the received signal at the time corresponding to the hypothesized path delay during the measurement time slot.

7. The method of claim 1, wherein the measurement based on the received signal is a square of an absolute value of an amplitude measurement of the received signal at the time corresponding to the hypothesized path delay during the measurement time slot.

8. The method of claim 1, wherein the step of, for each of the plurality of measurement time slots and for each of the hypothesized path delays, combining the measurement with the corresponding one of the plurality of cumulative metrics only if it was determined that no fade occurred comprises:
for each of the plurality of measurement time slots and for each of the hypothesized path delays, coherently combining the measurement with the corresponding one of the plurality of cumulative metrics only if it was determined that no fade occurred.

9. The method of claim 1, wherein the step of, for each of the plurality of measurement time slots and for each of the hypothesized path delays, combining the measurement with the corresponding one of the plurality of cumulative metrics only if it was determined that no fade occurred comprises:
for each of the plurality of measurement time slots and for each of the hypothesized path delays, non-coherently combining the measurement with the corresponding one of the plurality of cumulative metrics only if it was determined that no fade occurred.

10. The method of claim 1, further comprising:
supplying the determined real path delays to RAKE receiver circuitry for use in receiving the received signal.

11. The method of claim 1, wherein the step of, for each of the plurality of measurement time slots and for each of the hypothesized path delays, determining whether a fade occurred comprises:
for each of the plurality of measurement time slots and for each of the hypothesized path delays, using one or more previously determined channel estimates to determine whether a fade occurred.

12. An apparatus for estimating path delays experienced by a received signal, the method comprising:
logic that hypothesizes a plurality of path delays;
logic that makes a measurement based on the received signal for each of a plurality of measurement time slots and for each of the hypothesized path delays;
logic that determines, for each of the plurality of measurement time slots and for each of the hypothesized path delays, whether a fade occurred;
logic that combines the measurement with a corresponding one of a plurality of cumulative metrics for each of the plurality of measurement time slots and for each of the hypothesized path delays only if it was determined that no fade occurred; and
logic that uses the corresponding one of the plurality of cumulative metrics to determine whether the hypothesized path delay corresponds to a real path delay for each of the plurality of hypothesized path delays.

13. The apparatus of claim 12, further comprising:
logic that combines the measurement with an additional cumulative metric whenever it is determined that no fades occurred for any of the hypothesized path delays for each of the plurality of measurement time slots; and
logic that uses the additional cumulative metric to determine whether a real path delay exists between two of the hypothesized path delays.

14. The apparatus of claim 12, further comprising:
logic that combines the measurement with an additional cumulative metric for each of the plurality of measurement time slots; and
logic that uses the additional cumulative metric to determine whether a real path delay exists between two of the hypothesized path delays.

15. The apparatus of claim 12, wherein the logic that combines the measurement with the corresponding one of a plurality of cumulative metrics for each of the plurality of measurement time slots and for each of the hypothesized path delays only if it was determined that no fade occurred comprises logic that adds the measurement to the corresponding one of the plurality of cumulative metrics only if it was determined that no fade occurred.

16. The apparatus of claim 12, wherein the measurement based on the received signal is an amplitude measurement of the received signal at a time corresponding to the hypothesized path delay during the measurement time slot.

17. The apparatus of claim 12, wherein the measurement based on the received signal is an absolute value of an amplitude measurement of the received signal at the time corresponding to the hypothesized path delay during the measurement time slot.

18. The apparatus of claim 12, wherein the measurement based on the received signal is a square of an absolute value of an amplitude measurement of the received signal at the time corresponding to the hypothesized path delay during the measurement time slot.

19. The apparatus of claim 12, wherein the logic that combines the measurement with the corresponding one of the plurality of cumulative metrics for each of the plurality of measurement time slots and for each of the hypothesized path delays only if it was determined that no fade occurred comprises:
logic that coherently combines the measurement with the corresponding one of the plurality of cumulative metrics for each of the plurality of measurement time slots and for each of the hypothesized path delays only if it was determined that no fade occurred.

20. The apparatus of claim 12, wherein the logic that combines the measurement with the corresponding one of the plurality of cumulative metrics for each of the plurality of measurement time slots and for each of the hypothesized path delays only if it was determined that no fade occurred comprises:
logic that non-coherently combines the measurement with the corresponding one of the plurality of cumulative metrics for each of the plurality of measurement time slots and for each of the hypothesized path delays only if it was determined that no fade occurred.

21. The apparatus of claim 12, further comprising:
logic that supplies the determined real path delays to RAKE receiver circuitry for use in receiving the received signal.

22. The apparatus of claim 21, further comprising, the RAKE receiver circuitry.

23. The apparatus of claim 12, wherein the logic that determines, for each of the plurality of measurement time slots and for each of the hypothesized path delays, whether a fade occurred comprises:
logic that uses one or more previously determined channel estimates to determine, for each of the plurality of measurement time slots and for each of the hypothesized path delays, whether a fade occurred.
